(19) United States
(12) Patent Application Publication
(10) Pub. No.: US 2014/0330888 A1
(43) Pub. Date: Nov. 6, 2014

(54) DYNAMICALLY MODIFYING A FRAME RATE OF DATA TRANSMISSION ASSOCIATED WITH AN APPLICATION EXECUTING ON A DATA SERVER ON BEHALF OF A CLIENT DEVICE TO THE CLIENT DEVICE

(71) Applicant: NVIDIA Corporation, Santa Clara, CA (US)

(72) Inventor: Maulick Dave, Mumbai (IN)

(73) Assignee: NVIDIA Corporation, Santa Clara, CA (US)

(21) Appl. No.: 13/886,293

(22) Filed: May 3, 2013

(51) Int. Cl. H04L 29/06

(52) U.S. Cl. CPC H04L 67/42
USPC 709/203

(57) ABSTRACT

A method includes continuously monitoring, through a data server executing an application on behalf of a client device communicatively coupled thereto and/or a data processing device communicatively coupled to the data server, a data bandwidth supported by the client device. The method also includes dynamically modifying, through the data server and/or the data processing device, a frame rate of the data transmission associated with the application to the client device based on the continuously monitored data bandwidth.

### FIELD OF DISCLOSURE

This disclosure relates generally to cloud-computing systems and, more particularly, to a method, a device and/or a system of dynamically modifying a frame rate of data transmission associated with an application executing on a data server on behalf of a client device to the client device.

### BACKGROUND

A cloud-computing system may involve a data server executing an application (e.g., a game application) remotely on behalf of a client device (e.g., a desktop computer, a laptop computer, a mobile phone). The client device may offer limited/fluctuating data bandwidth support in cases such as a user thereof utilizing the client device during travel. Frame data associated with the application may be pushed at, say, 60 frames per second (FPS) by the data server, while the client device offers a data bandwidth support of only, say, 40 FPS. New frame data may, therefore, be only seen at the client device after 20 frames associated with the previous frame data. The aforementioned difference of 20 frames may spoil a user experience on the cloud-computing system.

### SUMMARY

Disclosed are a method, a device and/or a system of dynamically modifying a frame rate of data transmission associated with an application executing on a data server on behalf of a client device to the client device.

In one aspect, a method includes continuously monitoring, through a data server executing an application on behalf of a client device communicatively coupled thereto and/or a data processing device communicatively coupled to the data server, a data bandwidth supported by the client device. The method also includes dynamically modifying, through the data server and/or the data processing device, a frame rate of the data transmission associated with the application to the client device based on the continuously monitored data bandwidth.

In another aspect, a non-transitory medium, readable through a data server executing an application on behalf of a client device communicatively coupled thereto and/or a data processing device communicatively coupled to the data server, and including instructions embodied therein that are executable through the data server and/or the data processing device, is disclosed. The non-transitory medium includes instructions to continuously monitor a data bandwidth supported by the client device, and instructions to dynamically modify a frame rate of data transmission associated with the application to the client device based on the continuously monitored data bandwidth.

In yet another aspect, a system includes a client device, a computer network, and a data server communicatively coupled to the client device through the computer network. The data server is configured to execute an application on behalf of the client device. The data server is further configured to continuously monitor a data bandwidth supported by the client device, and to dynamically modify a frame rate of data transmission associated with the application to the client device based on the continuously monitored data bandwidth.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a cloud-computing system, according to one or more embodiments.

FIG. 2 is a schematic view of an example implementation of a frame rate controller on a data server of the cloud-computing system of FIG. 1.

FIG. 3 is a schematic view of the cloud-computing system of FIG. 1, with a data processing device thereof being configured to perform one or more tasks of the data server of FIG. 1, according to one or more embodiments.

FIG. 4 is a process flow diagram detailing the operations involved in dynamically modifying a frame rate of data transmission associated with an application executing on the data server of FIG. 1 on behalf of a client device to the client device, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of dynamically modifying a frame rate of data transmission associated with an application executing on a data server on behalf of a client device to the client device. Although the present embodiments have been described with reference to specific example embodiments, it will be evident that various modifications and changes may be made to these embodiments without departing from the broader spirit and scope of the various embodiments.

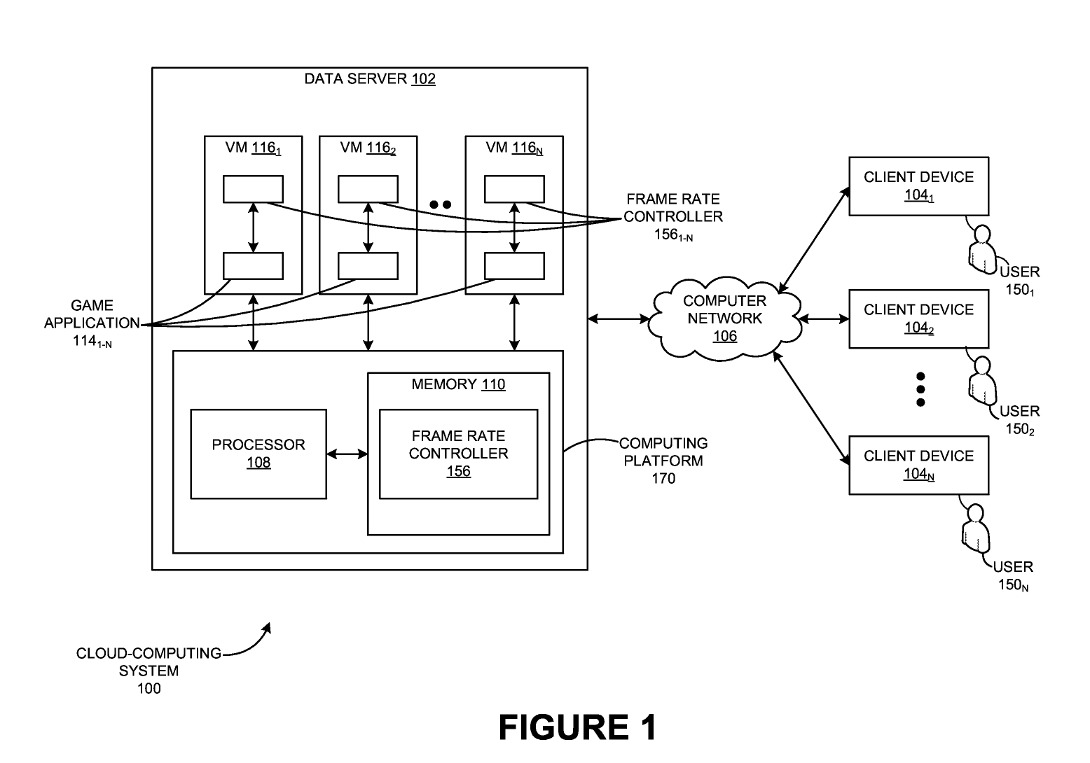

FIG. 1 shows a cloud-computing system 100, according to one or more embodiments. In one or more embodiments, cloud-computing system 100 may include a data server 102 (e.g., a data processing device) communicatively coupled to a client device 104_{1-N} (e.g., through a computer network 106 such as Internet, a Local Area Network (LAN) and a Wide Area Network (WAN), or, through a direct coupling). In one or more embodiments, client device 104_{1-N} may be a desktop computer, a laptop computer, a notebook computer, a netbook or a mobile device such as a mobile phone. Other forms of client device 104_{1-N} are within the scope of the exemplary embodiments discussed herein.

In one or more embodiments, data server 102 may include a processor 108 (e.g., a Central Processing Unit (CPU), a Graphics Processing Unit (GPU)) communicatively coupled to a memory 110 (a non-volatile memory and/or a volatile memory); memory 110 may include storage locations configured to be addressable through processor 108. FIG. 1 shows processor 108 and memory 110 as part of a computing platform 170 of data server 102. In one or more embodiments, a hypervisor (not shown) may be configured to consolidate virtual machines (VMs) 116_{1-N} on computing platform 170. In one or more embodiments, each VM 116_{1-N} may be configured to execute an application remotely utilizing the resources of data server 102 on behalf of client device 104_{1-N}. FIG. 1 shows N client devices 104_{1-N} merely for the sake of illustration. It is obvious that merely a single client device 104_{1-N} may suffice to realize concepts associated with the exemplary embodiments discussed herein.

Assuming cloud-computing system 100 to be associated with cloud-gaming, a user 150_{1-N} at client device 104_{1-N} may execute a game application 114_{1-N} on data server 102 through VM 116_{1-N}. In one or more embodiments, data frames associated with game application 114_{1-N} may be captured, encoded through data server 102 and transmitted to client device 104_{1-N}. The aforementioned transmission may occur at a constant frame rate selected by user 150_{1-N}.

Data bandwidth associated with client device 104_{1-N} may not remain steady. For example, user 150_{1-N} may be in a moving car or train, where switching and, hence, network variations are frequent. In the example scenario of cloud-gaming, gaming associated with game application 114_{1-N} may be offered at, say, either 30 frames per second (FPS) or 60 FPS. Frame data may be pushed at 60 FPS when client device 104_{1-N} coupled to data server 102 offers bandwidth capability thereof only at, say, 40 FPS. Now, if user 150_{1-N} initiates an action whereby a viewpoint of the game associated with game application 114_{1-N} is changed, the new frame data associated with the new viewpoint may only be seen after 20 frames associated with the previous frame data. The aforementioned difference of 20 frames may spoil a gaming experience of user 150_{1-N}.

Also, as the bandwidth offered by client device 104_{1-N} decreases to render client device 104_{1-N} incapable of handling frame data at 60 FPS, resources such as processing capability and/or power may be wasted in churning out frame data at 60 FPS through data server 102. FIG. 1 shows a frame rate controller 156 executing on data server 102, according to one or more embodiments. In one or more embodiments, frame rate controller 156 may be an application and/or a software module executing on data server 102. While FIG. 1 shows frame rate controller 156 as being stored in memory 110, an instance of frame rate controller 156 (e.g., frame rate controller 156_{1-N}) may execute on each VM 116_{1-N}. In one or more embodiments, frame rate controller 156_{1-N} (e.g., executing on processor 108) may be configured to continuously monitor a data bandwidth supported by client device 104_{1-N}. Now, in one or more embodiments, if the data bandwidth supported by client device 104_{1-N} falls below a threshold (e.g., a threshold value stored in memory 110) beyond which client device 104_{1-N} is incapable of handling a selected frame rate, frame rate controller 156_{1-N} may be configured to limit (or, cap) the frame rate of game application 114_{1-N} executing on data server 102.

In one or more embodiments, the abovementioned capping of the frame rate may be done to reduce the frame rate to a value that a current data bandwidth of client device 104_{1-N} is capable of handling. In one or more embodiments, when the data bandwidth reaches a normal value thereof, frame rate controller 156_{1-N} may be configured to restore previously selected frame rates (e.g., selected through a user interface (not shown) on client device 104_{1-N}).

In one or more embodiments, as the workload on a processor (e.g., a GPU) of client device 104_{1-N} is lessened, power consumed therethrough may be lessened too. Further, in one or more embodiments, by pumping frame data at a frame rate that client device 104_{1-N} is capable of handling, latency associated with the process may be kept in check.

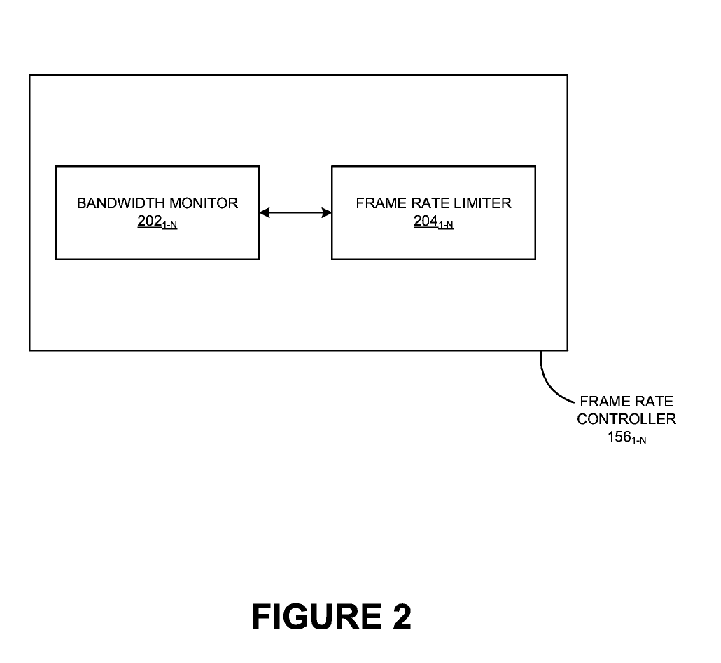

FIG. 2 shows an example implementation of frame rate controller 156_{1-N}. Frame rate controller 156_{1-N} may include two components (e.g., software modules) thereof, viz. a bandwidth monitor 202_{1-N} and a frame rate limiter 204_{1-N}. Both components may execute on processor 108. Bandwidth monitor 202_{1-N} may continuously monitor the data bandwidth offered by client device 104_{1-N} coupled to data server 102; data bandwidth may be a function of capabilities of client device 104_{1-N} and/or network (e.g., computer network 106) bandwidth. For example, bandwidth monitor 202_{1-N} may continuously poll client device 104_{1-N} for data pertaining to the data bandwidth. Said data may be analyzed through processor 108 to calculate a best possible frame rate of transmission to client device 104_{1-N}. If the data bandwidth remains below a threshold value thereof beyond a threshold amount of time (e.g., determined experimentally), frame rate limiter 204_{1-N} may be activated to limit the frame rate to client device 104_{1-N}.

The best possible frame rate at a given data bandwidth may depend on a number of factors such as a size of a single frame for a particular game application 114_{1-N} and playability of the game associated with game application 114_{1-N} at a given FPS. Limiting the frame rate through frame rate limiter 204_{1-N} may involve dynamically limiting the frame rate to a numerical value that is capable of being handled through client device 104_{1-N}.

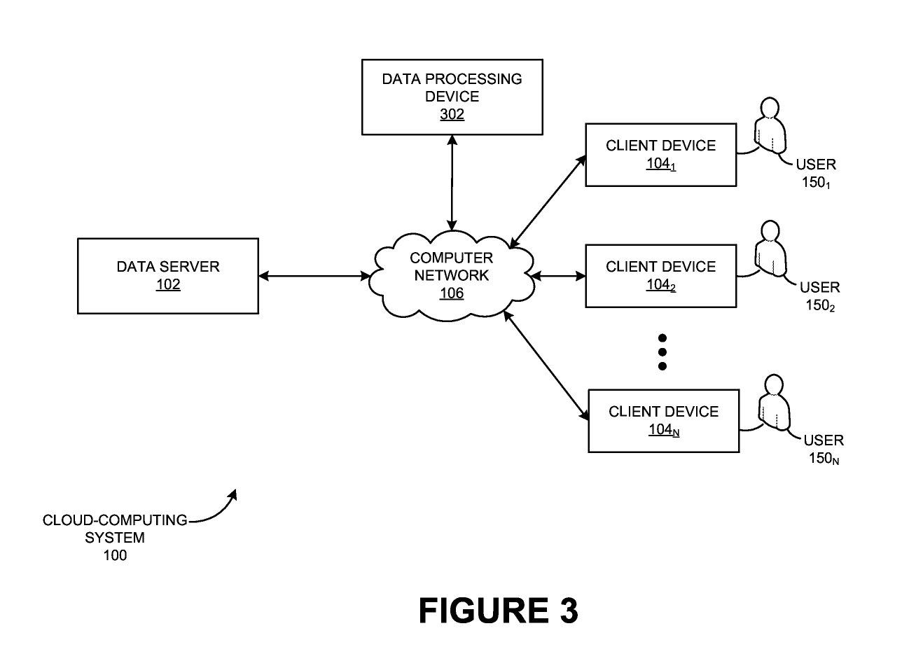

It should be noted that frame rate controller 156_{1-N} may not be required to execute on data server 102 alone. The abovementioned dynamic modification of the frame rate may, for example, be offered as a service. FIG. 3 shows a data processing device 302 in cloud-computing system 100 configured to perform the bandwidth monitoring and the frame rate limiting discussed above. Data processing device 302 may solely be employed to perform the aforementioned processes on behalf of data server 102 and/or client device 104_{1-N}. Alternately data processing device 302 may perform the processes in conjunction with data server 102. In one or more embodiments, data processing device 302 may be another server device or a “box” solution with the instructions associated with the bandwidth monitoring and the frame rate limiting implemented in firmware. FIG. 3 shows data processing device 302 as being communicatively coupled to data server 102 through computer network 106. Other implementations are within the scope of the exemplary embodiments discussed herein.

It should be noted that instructions associated with frame rate controller 156_{1-N} may be packaged with game application 114_{1-N} and/or an operating system (not shown) executing on data server 102 and/or data processing device 302. Further, said instructions may be embodied in a non-transitory medium (e.g., a Compact Disc (CD), a Digital Video Disc (DVD), a Blu-ray disc®, a hard drive; appropriate instructions may be downloaded to the hard drive) readable through data server 102 and/or data processing device 302. All variations are within the scope of the exemplary embodiments discussed herein. Further, exemplary embodiments are not limiting to game application 114_{1-N}; all applications necessitating dynamic modification of the frame rate discussed above are within the scope of the exemplary embodiments discussed herein.

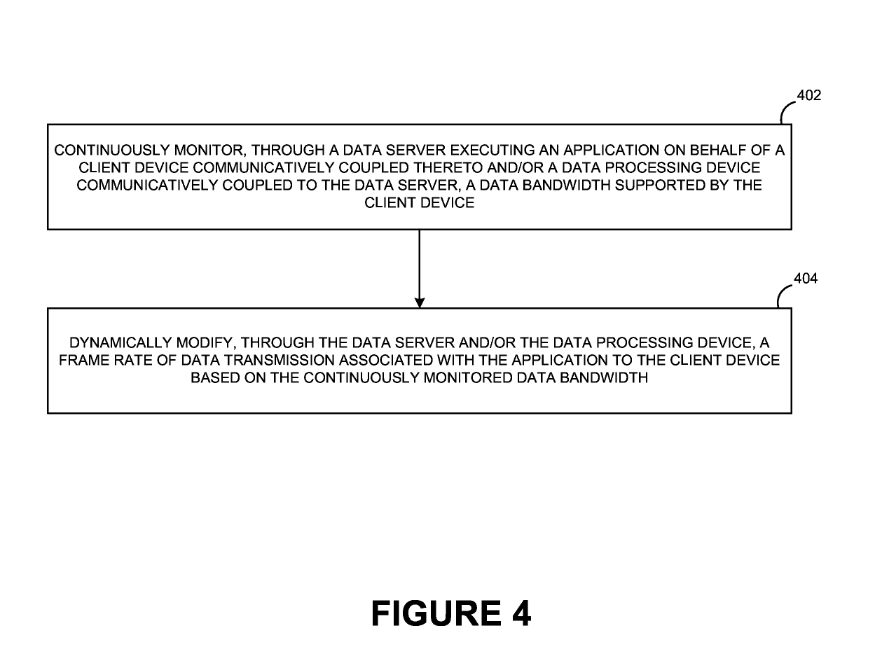

FIG. 4 shows a process flow diagram detailing the operations involved in dynamically modifying a frame rate of data transmission associated with an application (e.g., game application 114_{1-N}) executing on data server 102 on behalf of client device 104_{1-N} to client device 104_{1-N}, according to one or more embodiments. In one or more embodiments, operation 402 may involve continuously monitoring, through data server 102 and/or data processing device 302 communicatively coupled to data server 102, a data bandwidth supported by client device 104_{1-N}. In one or more embodiments, operation 404 may then involve dynamically modifying, through data server 102 and/or data processing device 302, the frame rate of the data transmission associated with the application to client device 104_{1-N} based on the continuously monitored data bandwidth.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., data server 102, data processing device 302). Accordingly, the specification and drawings are to be regarded in an illustrative rather than a restrictive sense.

What is claimed is:

1. A method comprising:
continuously monitoring, through at least one of a data server executing an application on behalf of a client device communicatively coupled thereto and a data processing device communicatively coupled to the data server, a data bandwidth supported by the client device; and
dynamically modifying, through the at least one of the data server and the data processing device, a frame rate of data transmission associated with the application to the client device based on the continuously monitored data bandwidth.

2. The method of claim 1, further comprising:
executing the application on the data server through a virtual machine consolidated on a computing platform thereof; and
executing an instance of a frame rate controller on the virtual machine to continuously monitor the data bandwidth supported by the client device and to dynamically modify the frame rate of the data transmission associated with the application to the client device.

3. The method of claim 1, wherein the continuous monitoring of the data bandwidth further comprises:
continuously polling, through the at least one of the data server and the data processing device, the client device for data pertaining to the data bandwidth supported therethrough; and
analyzing, through the at least one of the data server and the data processing device, the data pertaining to the data bandwidth to calculate a best possible frame rate of the data transmission to the client device.

4. The method of claim 3, further comprising limiting, through the at least one of the data server and the data processing device, the frame rate of the data transmission to the client device when the data bandwidth remains below a threshold value beyond a threshold amount of time.

5. The method of claim 4, further comprising restoring, through the at least one of the data server and the data processing device, the frame rate of the data transmission to the client device to a higher value thereof when the data bandwidth exceeds the threshold value.

6. The method of claim 1, comprising providing the continuous monitoring of the data bandwidth and the dynamic modification of the frame rate as a service through the data processing device.

7. The method of claim 2, comprising providing instructions associated with the frame rate controller packaged with at least one of the application and an operating system executing on the data server.

8. A non-transitory medium, readable through at least one of a data server executing an application on behalf of a client device communicatively coupled thereto and a data processing device communicatively coupled to the data server, and including instructions embodied therein that are executable through the at least one of the data server and the data processing device, comprising:
instructions to continuously monitor a data bandwidth supported by the client device; and
instructions to dynamically modify a frame rate of data transmission associated with the application to the client device based on the continuously monitored data bandwidth.

9. The non-transitory medium of claim 8, further comprising:
instructions to execute the application on the data server through a virtual machine consolidated on a computing platform thereof; and
instructions to execute an instance of a frame rate controller on the virtual machine to continuously monitor the data bandwidth supported by the client device and to dynamically modify the frame rate of the data transmission associated with the application to the client device.

10. The non-transitory medium of claim 8, wherein the instructions to continuously monitor the data bandwidth further comprises:
instructions to continuously poll the client device for data pertaining to the data bandwidth supported therethrough; and
instructions to analyze the data pertaining to the data bandwidth to calculate a best possible frame rate of the data transmission to the client device.

11. The non-transitory medium of claim 10, further comprising instructions to limit the frame rate of the data transmission to the client device when the data bandwidth remains below a threshold value beyond a threshold amount of time.

12. The non-transitory medium of claim 11, further comprising instructions to restore the frame rate of the data transmission to the client device to a higher value thereof when the data bandwidth exceeds the threshold value.

13. The non-transitory medium of claim 8, comprising instructions to provide the continuous monitoring of the data bandwidth and the dynamic modification of the frame rate as a service through the data processing device.

14. A system comprising:
a client device;
a computer network; and
a data server communicatively coupled to the client device through the computer network, the data server being configured to execute an application on behalf of the client device, and the data server further being configured to:
continuously monitor a data bandwidth supported by the client device, and
dynamically modify a frame rate of data transmission associated with the application to the client device based on the continuously monitored data bandwidth.

15. The system of claim 14, wherein:
the data server is configured to execute the application on the data server through a virtual machine consolidated on a computing platform thereof, and
wherein the data server is configured to execute an instance of a frame rate controller on the virtual machine to continuously monitor the data bandwidth supported by the client device and to dynamically modify the frame rate of the data transmission associated with the application to the client device.

16. The system of claim 14, wherein the data server is configured to continuously monitor the data bandwidth based on:
continuously polling the client device for data pertaining to the data bandwidth supported therethrough, and
analyzing the data pertaining to the data bandwidth to calculate a best possible frame rate of the data transmission to the client device.

17. The system of claim 16, wherein the data server is further configured to limit the frame rate of the data transmission to the client device when the data bandwidth remains below a threshold value beyond a threshold amount of time.

18. The system of claim 17, wherein the data server is further configured to restore the frame rate of the data transmission to the client device to a higher value thereof when the data bandwidth exceeds the threshold value.

19. The system of claim 14, wherein the continuous monitoring of the data bandwidth and the dynamic modification of the frame rate are performed through a data processing device external to the data server and communicatively coupled thereto as a service.

20. The system of claim 15, wherein instructions associated with the frame rate controller are packaged with at least one of the application and an operating system executing on the data server.
